(19) United States
(12) Patent Application Publication
(10) Pub. No.: US 2018/0284534 A1
(43) Pub. Date: Oct. 4, 2018

(54) QUANTUM DOT COLOR FILTER, LIQUID CRYSTAL PANEL AND LIQUID CRYSTAL DISPLAY DEVICE THEREOF

(71) Applicants: QINGDAO HISENSE ELECTRONICS CO., LTD., QINGDAO (CN); HISENSE INTERNATIONAL CO., LTD., QINGDAO (CN); HISENSE USA CORPORATION, SUWANEE, GA (US)

(72) Inventors: ZHICHENG SONG, QINGDAO (CN); ZHENGUO LIU, QINGDAO (CN); WEIDONG LIU, QINGDAO (CN); FULIN LI, QINGDAO (CN)

(21) Appl. No.: 15/857,579

(22) Filed: Dec. 28, 2017

(30) Foreign Application Priority Data
Mar. 28, 2017 (CN) 201710194873.4

(51) Int. Cl. G02F 1/1335

(52) U.S. Cl. CPC G02F 1/133514; G02F 1/133526; G02F 1/133602; G02F 1/133528; G02F 1/133512

(57) ABSTRACT

A quantum dot color filter, a liquid crystal panel and a liquid crystal display device, belonging to the field of liquid crystal display, are disclosed, where the quantum dot color filter comprising a quantum dot light conversion layer; a base panel arranged on a light incident side of the quantum dot conversion layer; and a protection layer arranged on a light emitting side of the quantum dot conversion layer, wherein a micro-lens array is arranged between the quantum dot conversion layer and the protection layer, the micro-lens array is configured to condense the light emitted from the quantum dot conversion layer. By utilizing the light convergence capability of the micro-lens array, the light emitted by the pixels in the quantum dot color filter is converged to a range of angle-of-view, thereby increasing the brightness within the range of angle-of-view, and improving the display effect of the liquid crystal display device.

### CROSS-REFERENCE TO RELATED APPLICATION

This application claims priority benefit of Chinese Patent Application No. 201710194873.4, filed on Mar. 28, 2017, which is hereby incorporated by reference in its entirety.

### TECHNICAL FIELD

The present application relates to the field of liquid crystal display technology, and in particular to, a quantum dot color filter, a liquid crystal panel and a liquid crystal display device.

### BACKGROUND

With the rapid development of liquid crystal display technology, the requirements of consumers for the color gamut of liquid crystal display device are increasing. Liquid crystal display device with high color gamut has become the mainstream of development. Applying a quantum dot color filter in a liquid crystal panel of a liquid crystal display device is an effective method for improving the color gamut of a liquid crystal display device.

### SUMMARY

According to a first aspect, an embodiment of the present application provides a quantum dot color filter including: a quantum dot light conversion layer; a base panel arranged on a light incident side of the quantum dot conversion layer; and a protection layer arranged on a light emitting side of the quantum dot conversion layer, wherein a micro-lens array is arranged between the quantum dot conversion layer and the protection layer, and the micro-lens array is configured to converge light emitted from the quantum dot conversion layer.

According to a second aspect, an embodiment of the present application provides a liquid crystal panel including the quantum dot color filter as above-mentioned.

According to a third aspect, an embodiment of the present application provides a liquid crystal display device, including at least one set of backlight module, and further including the liquid crystal panel as above-mentioned.

### BRIEF DESCRIPTION OF THE DRAWINGS

In order to make technical solutions in embodiments of the present application clearer, in the following, accompanying drawings needed to be used in the description of the embodiments will be briefly described. Apparently, the described drawings are merely some embodiments of present application. For persons skilled in the art, other drawings may be obtained based on these drawings without any creative effort.

FIG. 1 is a schematic structural diagram of a quantum dot color filter in related art;

FIG. 2A is a schematic structural diagram of a quantum dot color filter according to some embodiments of the present application;

FIG. 2B is a schematic structural diagram of pixels in the quantum dot color filter in FIG. 2A.

FIG. 3A is a schematic structural diagram of another quantum dot color filter according to some embodiments of the present application;

FIG. 3B is a schematic structural diagram of yet another quantum dot color filter according to some embodiments of the present application;

FIG. 4 is a schematic structural diagram of still another quantum dot color filter according to some embodiments of the present application;

FIG. 5A is a schematic structural diagram of a micro-lens array;

FIG. 5B is a schematic structural diagram of another micro-lens array;

FIG. 6 is a schematic structural diagram of a micro-lens array template;

FIG. 7 is a schematic diagram of a preparation process of a micro-lens array template;

FIG. 8A is a schematic structural diagram of a quantum dot color filter provided according to some embodiments of the present application; and

FIG. 8B is a schematic structural diagram of another quantum dot color filter according to some embodiments of the present application.

The symbols in the drawings are respectively represented:
100-quantum dot color filter;
1-base panel;
2-quantum dot light conversion layer;
21-black matrix;
22-pixels;
22a-red pixels; 22b-green pixels; 22c-blue pixels;
3-dichroic layer;
4-protection layer;
5-micro-lens array;
6-micro-lens array template;
200-backlight module;
300-glass base panel;
400-lower polarizer;
500-liquid crystal encapsulation layer;
600-upper polarizer;
a-substrate;
b-photoresist;
c-epoxy resin;
r-diameter of a micro-lens; and
h-height of a micro-lens.

### DESCRIPTION OF EMBODIMENTS

To make the technical solutions and advantages of the present application more clearly, the embodiments of the present application is hereinafter described in detail with reference to the accompanying drawings. All technical terms used in the embodiments of the present application have the same meanings as commonly understood by a person skilled in the art unless otherwise defined.

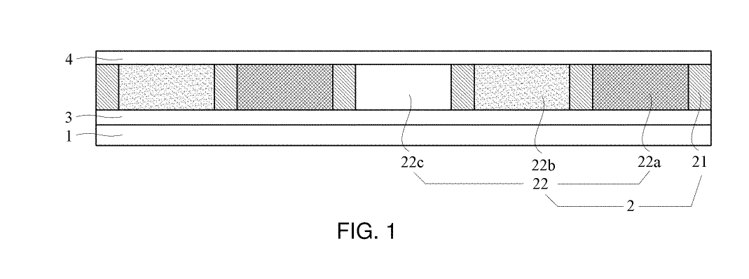

A quantum dot color filter is arranged on a side of the polarizer of the liquid crystal panel opposite to the liquid crystal. As shown in FIG. 1, a quantum dot light conversion layer 2 is arranged in a quantum dot color filter in the related art, and the quantum dot light conversion layer 2 comprises a plurality of pixels 22 and a black matrix 21 for separating the pixels 22. The pixels 22 comprise red pixels 22a, green pixels 22b, and blue pixels 22c. In which, the red pixels 22a and the green pixels 22b are formed by exposure and development of photo-curable resin mixed with red quantum dot material, and by exposure and development of photo-curable resin mixed with green quantum dot material respectively, and the blue pixels 22c can be formed by exposure and development of photo-curable resin mixed with blue quantum dot material, and also can be transparent pixels which are formed by photo-curable resin directly, where the transparent blue pixels are mainly used for that the backlight source emits blue light. The light emitted by the backlight is incident on one side of the quantum dot light conversion layer, and the quantum dot material in the pixels generates the red, green and blue light by excitation (when the blue pixels are transparent pixels, the light emitted by the backlight is directly transmitted from the blue pixels), and is emitted from the other side of the quantum dot light conversion layer.

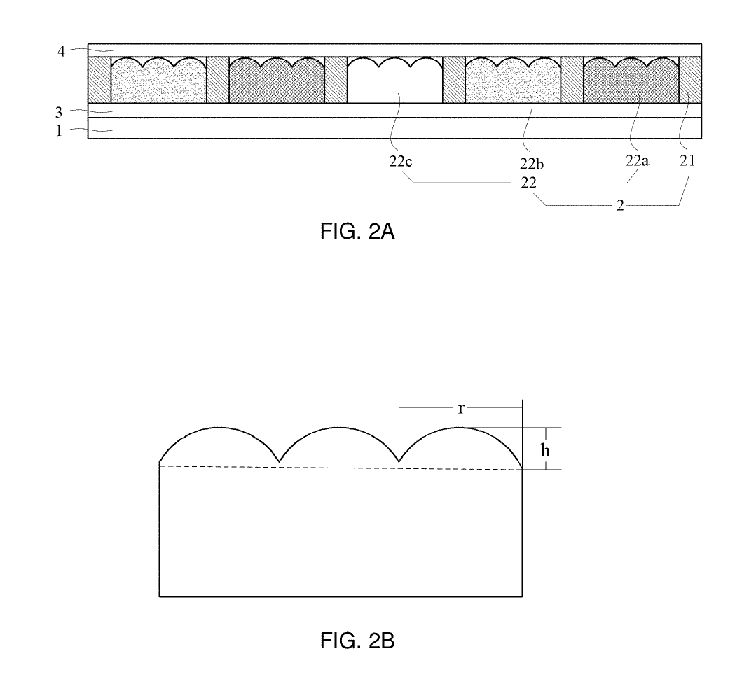

In some embodiments of the present application, a quantum dot color filter is provided. Referring to FIG. 2A, the quantum dot color filter includes a quantum dot light conversion layer 2, a base panel 1 arranged on a light incident side of the quantum dot conversion layer 2 and a protection layer 4 arranged on a light emitting side of the quantum dot conversion layer 2 (such as glass base panel, PMMA base panel, which will not be limited herein), where a micro-lens array is arranged between the quantum dot conversion layer 2 and the protection layer 4, and the micro-lens array is configured to condense the light emitted from the quantum dot conversion layer.

FIG. 2A is a schematic structural diagram of a quantum dot color filter according to some embodiments of the present application. A thickness of the black matrix 21 in a direction from the base panel 1 toward the protection layer 4 is greater than a thickness of the pixels 22 in a direction from the base panel 1 toward the protection layer 4, the micro-lens array is arranged on a surface of the light emitting side of the pixels 22 respectively, as shown in FIG. 2A. In some embodiments, a material of the pixels is the same with/different from that of the micro-lens array arranged on the pixels. The pixels and the micro-lens array arranged on the pixels may be integrally modeled or may be separately provided. A sum thickness of the pixels and the micro-lens array in a direction from the base panel toward the protection layer is not greater than the thickness of the black matrix in a direction from the base panel toward the protection layer. In some embodiments, a side of the black matrix facing the protection layer is in contact with the protection layer.

Those skilled in the art may understand that the pixels 22 comprises red pixels 22a, green pixels 22b, and blue pixels 22c in the quantum dot color filter, i.e., the micro-lens array is arranged on a surface of the light emitting side of red pixels 22a, green pixels 22b, and blue pixels 22c respectively. Wherein the red pixels 22a contains red quantum dot material, and the micro-lens array correspondingly arranged on the surface thereof can adopt red quantum dot material; the green pixels 22b contains green quantum dot material, and the micro-lens array correspondingly arranged on the surface thereof can adopt green quantum dot material; the red quantum dot material is excited by the light emitted by the backlight and emits corresponding red light, and the green quantum dot material is excited by the light emitted by the backlight source and emits corresponding green light. The blue pixels 22c may contain blue quantum dot material, and the blue quantum dot material is excited by the light emitted by the backlight source and emits blue light, the micro-lens array correspondingly arranged on the surface thereof can adopt blue quantum dot material. However, when the light emitted by the backlight source is blue, the blue pixels 22c may not contain blue quantum dot material, that is, the blue pixels 22c are transparent pixels which displays blue light by letting transmission of the blue light in the backlight. In this case, the micro-lens array correspondingly arranged on the surface of the blue pixels 22c may adopt the same material as that of the transparent pixels.

The micro-lens array may be arranged on a surface of the light emitting side of the quantum dot light conversion layer. In some embodiments, the micro-lens array includes at least one of the following: a cylindrical surface micro-lens array, a spherical micro-lens array and a prism array, but is not limited thereto. Wherein for the convenience of identification, the micro-lens array and the pixels are distinguished by dotted lines in the drawings, and such dividing line in the actual product may not exist. When the micro-lens array is a spherical micro-lens array, the convex curved surface of a lens in the micro-lens array is a spherical surface, the diameter r of the circumference at the bottom end of the convex curved surface is 1-3 μm, and a ratio of a height h of the convex curved surface to the diameter r is (0.25-0.5):1, as shown in FIG. 2B.

The quantum dot light conversion layer 2 includes a plurality of pixels 22 and a black matrix 21 for separating the pixels 22. It can be understood by a person skilled in the art that the pixels 22 includes red pixels 22a, green pixels 22b, and blue pixels 22c in the quantum dot color filter.

In some embodiments, the base panel 1 may be a transparent base panel (such as glass base panel). Moreover, in the case that the blue pixels 22c is a transparent pixels, a dichroic layer 3 may be arranged between the base panel 1 and the quantum dot light conversion layer 2. The dichroic layer 3 may reflect red light and green light and let blue light transmit.

In some embodiments, in the above quantum dot color filter, the surface of micro-lens in micro-lens array may be a spherical surface or an ellipsoid surface, and may also be designed as other forms of curved surfaces as required. Different shapes of the curved surfaces have different light convergence capabilities. Correspondingly, the angle-of-view and the center brightness of the liquid crystal panel using the quantum dot color filter also different.

When the convex curved surface is a spherical surface, the diameter of the circumference at a bottom of the spherical surface (such as the size indicated by r in FIG. 2B, hereinafter briefed as diameter) may be 1-3 micrometers (such as 1 micrometer, 2 micrometer, 3 micrometer and the like), and a ratio of a height of the spherical surface (such as the size indicated by h in FIG. 2B, that is, a distance from the bottom of the spherical surface to the top of the spherical surface) to the diameter may be (0.25˜0.5):1 (such as 0.25:1, 0.3:1, 0.35:1, 0.4:1, 0.45:1, 0.5:1 and the like.). That is, when the diameter of the spherical surface is 2 micrometers, the height of the spherical surface may be 0.5 A micrometers.

When the ratio of the height to the diameter of the spherical surface forming the micro-lens array is 0.5:1, the angle-of-view of the liquid crystal panel using the quantum dot color filter is about 100°, and when the ratio of the height to the diameter of the spherical surface forming the micro-lens array is about 5:12 (0.4:1), the angle-of-view is about 90°.

When the convex curved surface of the micro-lens structure on the surface of the pixels 22 is a spherical surface, the angle-of-view in the horizontal direction is the same as that in the vertical direction. When that is an aspherical surface, the angle-of-view in different directions will be different.

For the aspherical surface design, it may use optical simulation software to fit, and select different aspherical surface as a micro-lens arrangement, abstract the pixels as a Lambertian spotlight, adjust the lens design, and get the aspherical contour.

In the embodiments of the present application, the number of micro-lenses in the micro-lens array corresponding to each pixels 22 is not particularly limited, and there may be certain gap between two adjacent micro-lenses, or the adjacent micro-lenses may be overlapped. The surfaces of two adjacent micro-lenses are arranged tangentially.

The micro-lens arrays on the surfaces of the red pixels 22a, the green pixels 22b and the blue pixels 22c may have the same structure, and may have different structures according to the red, green and blue light properties, for example, may have different shapes, different sizes, different numbers of convex surfaces, and/or different arrangements, in order to further improve the brightness of the liquid crystal panel within the angle-of-view range. For example, the number of lenses in the micro-lens array on the light emitting side surface of the red quantum dot may be less than that of lenses on the light emitting side surface of the green pixels, as the case may be, which is not limited herein in the present application.

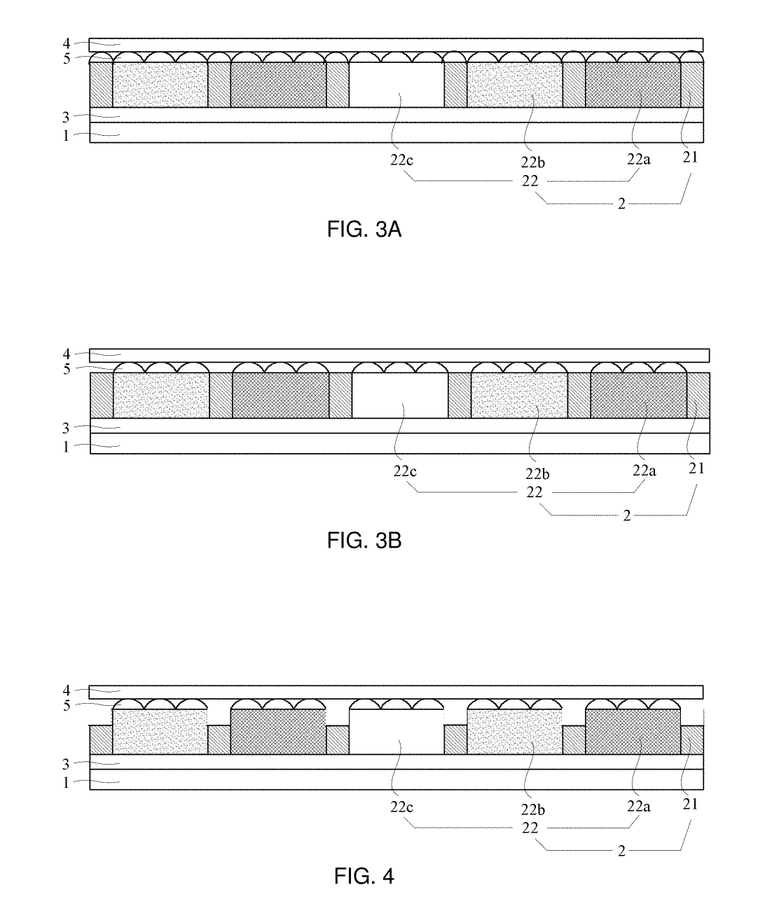

FIG. 3A is a schematic structural diagram of another quantum dot color filter according to some embodiments of the present application. The quantum dot light conversion layer 2 of the quantum dot color filter includes a plurality of pixels 22 and a black matrix 21 for separating the pixels, a thickness of the black matrix 21 in a direction from the base panel toward the protection layer is equal to a thickness of the pixels 22 in a direction from the base panel toward the protection layer, and the micro-lens array is arranged on a side of both the pixels and the black matrix facing the protection layer, as shown in FIG. 3A.

Wherein the micro-lens arrays also may be arranged on a side of the plurality of pixels facing the protection layer respectively, as shown in FIG. 3B.

In some embodiments, material of the micro-lens array and may be different from that of the pixels. For example, the material of the micro-lens array may be, but not limited to, a polyurethane film, a polycarbonate film or a polyethylene terephthalate film.

The micro-lens array and the quantum dot conversion layer are arranged in parallel. In some embodiments, the base panel, the quantum dot light conversion layer, the micro-lens array, and the protection layer are, and adjacent layers thereof are in contact with each other.

FIG. 4 is a schematic structural diagram of another quantum dot color filter according to some embodiments of the present application. The quantum dot light conversion layer of the quantum dot color filter includes a plurality of pixels and a black matrix for separating the pixels, a thickness of the black matrix in a direction from the base panel toward the protection layer is not greater than a thickness of the pixels in a direction from the base panel toward the protection layer, the micro-lens arrays are arranged on a surface of light emitting side of the pixels respectively, as shown in FIG. 4.

Wherein material of the pixels is the same as that of the micro-lens array arranged on the pixels. In some embodiments, a side of the micro-lens array facing the protection layer is in contact with the protection layer, as shown in FIG. 3B.

In the existing quantum dot color filter, due to the quantum dot light conversion layer 2 has a relative thin thickness and the optical path thereof is relative short, resulting in that the excitation of the quantum dot material in the pixels 22 is insufficient, so that the efficiency of the light conversion is low and the brightness of the liquid crystal panel is weak. However, if the thickness of the quantum dot light conversion layer is increased, the preparation process of the quantum dot color filter will be more difficult. Based on this, the embodiments of the present application provide a quantum dot color filter, to increase the brightness of the quantum dot color filter within the range of the angle-of-view, when the quantum dot light conversion layer 2 has a relatively thin thickness. In some embodiments, in the quantum dot color filter provided by the embodiments of the present application, a micro-lens array formed by a plurality of convex curved surfaces is arranged on the surface of the light emitting side of the pixels 22. By utilizing the light convergence capability of the micro-lens array, the light emitted by the pixels points 22 in the quantum dot color filter is converged into the range of the angle-of-view of the liquid crystal display device, thereby increasing the brightness in the range of the angle-of-view, improving the display effect of the liquid crystal display device, and promoting the development of the high color gamut liquid crystal display device.

The embodiments of the present application provides a preparation method for the quantum dot color filter as shown in FIG. 2A, FIG. 3B and FIG. 4, when the material of the micro-lens array is the same as that of the pixels. Referring to any one of FIG. 2A, FIG. 3B, or FIG. 4, and FIG. 6, the preparation method includes the following steps:

Step S11, forming a black matrix 21;

Step S12, filling a gap of the black matrix 21 with a photo-curable resin system for forming pixels;

Step S13, embossing a transparent micro-lens array template 6 with a plurality of concave curved surfaces on the surface of the photo-curable resin system;

Step S14, exposing the photo-curable resin system, removing the micro-lens array template after the photo-curable resin system has been cured, and then developing to form pixels 22 of which the surface has a micro-lens array, thereby forming a quantum dot conversion layer; and

Step S15: mounting a base panel on a light incident side of the formed quantum dot conversion layer, and mounting a protection layer 4 on a light emitting side of the formed quantum dot conversion layer, wherein the quantum dot conversion layer, the base panel and the protection layer are arranged in parallel to each other, thereby forming a quantum dot color filter.

In this preparation method, by embossing a transparent micro-lens array template 6 with a plurality of concave curved surfaces on the surface of the photo-curable resin system, exposing and curing the photo-curable resin system, in this way, under the limitation of the micro-lens array template 6, the convex curved surface formed by the surface of the pixels 22 and matching the concave curved surface of the micro-lens array template 6, is obtained after curing of the photo-curable resin system, thereby forming a micro-lens array structure on the surface of the pixels 22. By utilizing the light convergence capability of the micro-lens array, the light emitted by the pixels in the quantum dot color filter is converged to the range of the angle-of-view, thereby increasing the brightness within the range of the angle-of-view, and improving the display effect of the liquid crystal display device.

Those skilled in the art may understand that the photo-curable resin system for forming pixels includes a photo-curable resin system for forming red pixels, a photo-curable resin system for forming green pixels and a photo-curable resin system for forming blue pixels. Where, the photo-curable resin system for forming red pixels includes matrix resin, photoinitiator and red quantum dot material; the photo-curable resin system for forming green pixels includes matrix resin, photoinitiator and green quantum dot material; and the photo-curable resin system for forming blue pixels may only include matrix resin and photo initiator for forming transparent pixels, and it may also include matrix resin, photoinitiator and blue quantum dot material. The red pixels, the green pixels and the blue pixels should be obtained by exposing and developing respectively according to a certain order.

The matrix resin in the curable resin system may be at least one of a transparent resin such as an unsaturated polyester resin, an epoxy resin, an acrylic resin, and a thiol/vinyl monomer photopolymerization system and the like. The photoinitiator may be at least one of a photo initiator such as a benzoin photo initiator, a benzil photo initiator, a benzophenone photo initiator, a thioxanthone photo initiator, and a chinoquinone photo initiator and the like.

Further, in the above preparation method, in order to facilitate removal of the micro-lens array template 6, a mold release agent may be coated on the concave curved surface of the micro-lens array template 6.

Further, in the above preparation method, a micro-lens array template 6 may be used for each pixels 22 respectively during the exposure process; and a complete micro-lens array template 6 may also be used, and in such a micro-lens array template 6, a concave curved surface is formed at least in a region corresponding to the pixels 22.

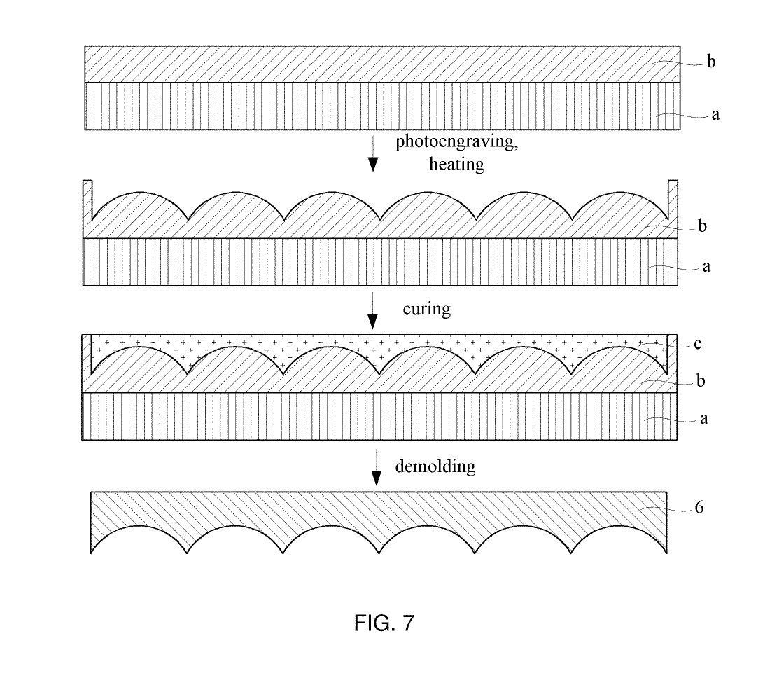

Further, in the above preparation method, the material of the micro-lens array template 6 may be material such as epoxy resin which is transparent and strong, on one hand to ensure the penetration of the light during the exposure process, and on the other hand to ensure accuracy of the formed micro-lens array structure. Referring to FIG. 7, and taking the epoxy resin material as an example, a preparation method of the micro-lens array template 6 includes:

Step a1, forming a positive photoresist layer b on a substrate a.

Step a2, after photoengraving the photoresist layer b, obtaining a photoresist layer with a micro-column array structure, heating, melting and cooling the positive photoresist layer having the micro-column array structure, thereby obtaining a template having the micro-convex lens array structure; and

Step a3: injecting epoxy resin and curing agent into a template having a micro-convex lens array structure and curing the epoxy resin to obtain a micro-lens array template after being demolded.

In the above step a1, the positive photoresist may be one or more combinations of linear photosensitive compounds such as RZJ-390PJ, BP-212, RZJ-304 and the like. The substrate a may be glass or metal. The surface of the substrate may be cleaned before coating the photoresist b.

In the above step a2, the structure of the micro-lens array may be simulated by a ray-tracing method, and the positive photoresist layer may be exposed by using a digital micro-mirror (DMD).

In the above step a3, the heating temperature may be 82° C. to 88° C. The micro-convex lens structure is formed after the micro-column structure of the positive photoresist layer is melted, thereby forming a micro-convex lens array on the substrate a.

In the above step a3, the curing agent may be amine curing agent, and the curing temperature may be 50° C. to 170° C., such as 50° C., 60° C., 80° C., 100° C., 120° C., 150° C., 170° C. and the like. For ease of demolding, mold release agent may be coated in the template having a micro-convex lens array structure.

Further, regarding the forming process of the black matrix 21 in step S11 in the above preparation method, it is not particularly limited in the embodiments of the present application and a conventional technical means in the art may be used. For example, the black matrix 21 may be formed by a process which combines photoengraving and etching. Material of the black matrix 21 may be opaque material such as metal of chromium (Cr) or phenolic resin.

Some embodiments of the present application further provide a method for manufacturing a quantum dot color filter as shown in FIGS. 3A and 3B, when the material of the microlens array is different from the material of the pixels. Referring to any one of FIG. 3A and FIG. 3B, and FIG. 6, the preparation method includes the following steps:

Step S21, forming a black matrix 21;

Step S22, filling a gap of the black matrix 21 with a photo-curable resin system for forming pixels, and exposing and developing the photo-curable resin system to form the pixels 22;

Step S23, adhering a micro-lens array whose material is different from that of the pixels on the surface of light emitting side of the pixels 22 by optical glue, or adhering the micro-lens array on a side of both the pixels 22 and the black matrix 21 facing the protection layer by the optical glue, thereby forming a quantum dot conversion layer to which the micro-lens array is attached; and

Step S24: mounting a base panel on the light incident side of the formed quantum dot conversion layer with the micro-lens array attached, and mounting the protection layer on the light emitting side of the formed quantum dot conversion layer, wherein the quantum dot conversion layer, the base panel, and the protection layers are arranged in parallel to each other, thereby forming a quantum dot color filter.

In the preparation method, after the forming of the pixels 22, adhering the micro-lens array on the light emitting side of the pixels 22, so that by using the light convergence capability of the micro-lens array, the light emitted by the pixels 22 in the quantum dot color filter is converged to the range of the angle-of-view of liquid crystal display device, so as to increase the brightness within the range of the angle-of-view, and improve the display effect of the liquid crystal display device, in the case that the quantum dot light conversion layer 2 has a relative thin thickness.

In the preparation method, the forming process of the black matrix 21 and the forming process of the pixels 22 may be performed according to the contents described above, and details will not be repeated herein again.

Further, in one implementation of the embodiments of the present application, when the material of the micro-lens array is polyurethane, polycarbonate, polyethylene terephthalate and the like, the micro-lens array is prepared by a method of embossing, which include:

A polyurethane film, a polycarbonate film, or a polyethylene terephthalate film is placed on the surface of a micro-lens array template having a concave micro-lens array structure and is heated to obtain a micro-lens array having a convex surface.

The temperature of the above-mentioned heating is not critical and may be determined depending on the type of film, as long as the film can be softened to form a micro-lens array.

Wherein, the thickness of the polyurethane film, the polycarbonate film or the polyethylene terephthalate film may be 0.2 micrometers to 0.5 micrometers, such as 0.2 micrometers, 0.3 micrometers, 0.4 micrometers, 0.5 micrometers and the like.

In an embodiment of the present application, when the material of the micro-lens array is an epoxy resin, the micro-lens array may be prepared by the following method:

The micro-lens array template 6 having a concave micro-lens array structure is filled with epoxy resin and a curing agent, so as to demold the epoxy resin after being cured, thereby obtaining a micro-lens array having a convex surface.

Wherein, the curing agent may be amine curing agent, and the epoxy resin is cured by heating.

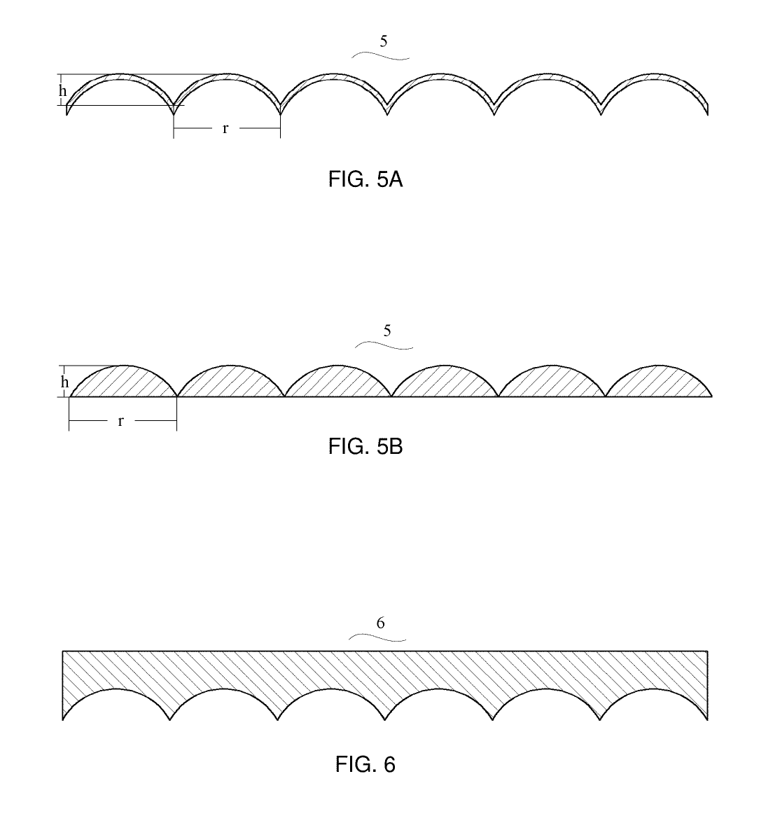

The structure of the micro-lens array prepared by the above two methods is different. As shown in FIG. 5A, in the micro-lens array obtained by the method of embossing, the surface opposite to one surface having the convex micro-lens array structure has a concave micro-lens array, and in some embodiments, the size of the micro-lens surface refers to a size of the convex surface in terms of the micro-lens array of the structure. As shown in FIG. 5B, in the micro-lens array obtained by the epoxy resin curing method, the surface opposite to a surface of a structure having the convex micro-lens array is a plane surface.

The above-mentioned micro-lens array template 6 with a concave micro-lens array structure may be prepared by the preparation method for a quantum dot color filter, when the material of the micro-lens array is the same as that of the pixels, as described in the embodiments of the preparation method for preparing a quantum dot color filter, according to the embodiments shown in FIG. 2A, FIG. 3B, and FIG. 4 of the present application. Details will not be repeated herein again.

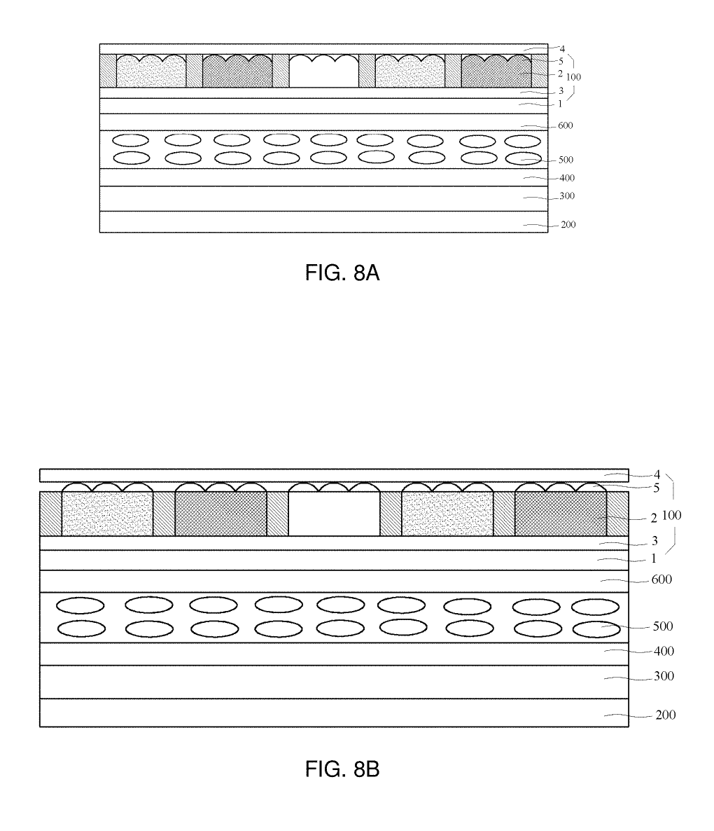

Some embodiments of the present application provide a liquid crystal panel, which includes the quantum dot color filter described above. As shown in FIGS. 8A and 8B, the upper polarizer 600 is arranged on a surface of the light incident side of a quantum dot color filter 100, and the upper polarizer 600 and the quantum dot color filter 100 are arranged in parallel.

In the liquid crystal panel also provided by some embodiments of the present application, the light emitted by the pixels in the quantum dot color filter is converged to the range of the angle-of-view, thereby increasing the brightness within the range of the angle-of-view, and improving the display effect of the liquid crystal display device when the dot light conversion layer of quantum dot color filter has a relative thin thickness.

Some embodiments of the present application also provide a liquid crystal display device. The liquid crystal display device includes at least one set of backlight module, and further includes the above liquid crystal panel.

The liquid crystal display device described in some embodiments of the present application may be any product or component having a display function, such as a liquid crystal television, a laptop screen, a tablet computer, a cell phone and the like.

The technical solutions of the present application are described in detail below through embodiments. In the following embodiments, the raw materials is used without indication of the manufacturer and specifications, and are all conventional products that can be bought from the market.

Some embodiments of the present application also provide a preparation method for a micro-lens array template for forming a micro-lens array structure, and material of the micro-lens array template is epoxy resin. Referring to FIG. 7, the preparation method includes:

Step 101, using a glass plate as a substrate, and cleaning the surface of the glass plate;

Step 102, coating a surface of the substrate obtained in step 101 with a RZJ-304 type positive photoresist to form a positive photoresist layer;

Step 103, according to a preset micro-lens array structure, simulating the structure of the micro-lens array by a ray-tracing method, and digitally etching the positive photoresist layer formed in step 102 by using a digital micro-mirror (DMD). Where the DMD used is composed of 1024×768 micro-mirrors with programmable controllable reflection angles, the laser light after beam expansion and collimation is reflected by the DMD and then enters into an optical system to expose the photoresist, these exposed unites are spliced piece-by-piece, and a photoresist layer with a micro-column array structure is obtained after being developed.

Step 104, heating the photoresist layer having a micro-column array structure obtained in step 103 at 85° C., so that the positive photoresist layer having a micro-column array structure is melted and then cooled to obtain a template having a micro-convex lens array structure; and

Step 105, coating mold release agent on the surface of a template having a micro-convex lens array structure, injecting epoxy resin E-51 and triethylenetetramine curing agent into the template having a micro-convex lens array structure, and heating and curing the epoxy resin at 100° C., to obtain a high intensity and transparent micro-lens array template after being demolded.

Referring to FIG. 2A, some embodiments of the present application provides a quantum dot color filter. The quantum dot color filter provided in this embodiment includes a transparent base panel 1 formed of glass material, a layer 3 able to transmit blue light and to reflect red light and green light, a quantum dot light conversion layer 2, and a protection layer 4 formed of glass, and they are arranged sequentially from bottom to top. The quantum dot light conversion layer 2 includes a plurality of pixels 22 and a black matrix 21 formed of metal of chromium for separating the pixels 22. The pixels 22 includes red pixels 22a, green pixels 22b and blue pixels 22c, where the blue pixels 22c may be transparent.

The surface of light emitting side of each pixels 22 has a micro-lens array formed by convex spherical surface. The diameter of the circumference at the bottom of the spherical surface is 2 μm, the height of the spherical surface is 1 μm, and the two adjacent spheres are tangential.

The total thickness of the pixels 22 in the quantum dot color filter is 50 μm (the distance from the surface of the transparent base panel 1 to the top of the spherical surface of the pixels 22).

In some embodiments, photo-curable resin used to form the pixels of the quantum dot color filter is consisted of: matrix resin: methyl methacrylate: photo initiator: a benzoin dimethyl ether.

The quantum dot color filter is prepared by the following method:

Step 201, forming a dichroic layer 3 (the dichroic layer transmits blue light and reflects red light and green light) on the transparent base panel 1, and forming a black matrix 21 on the dichroic layer 3 by photoengraving and etching process.

Step 202, filling photo-curable resin mixed with red quantum dot material into the gap of the black matrix 21; embossing the micro-lens array template prepared according to the method shown in the embodiment shown in FIG. 7 on the surface of the light-curing resin, after coating the surface of the micro-lens array template with a mold release agent; exposing the photo-curable resin, and removing the micro-lens array template after the photo-curable resin is cured, and then developing to form a red pixels 22a with a surface having a micro-lens array structure;

filling a photo-curable resin mixed with green quantum dot material into the gap of the black matrix 21; embossing the micro-lens array template prepared according to the method shown in the embodiment shown in FIG. 7 on the surface of the light-curing resin, after coating the surface of the micro-lens array template with a mold release agent; exposing the photo-curable resin, and removing the micro-lens array template after the photo-curable resin is cured, and then developing to form a green pixels 22b with a surface having a micro-lens array structure;

filling a photo-curable resin that has not been mixed with quantum dot material into the gap of the black matrix 21; embossing the micro-lens array template prepared according to the method shown in the embodiment shown in FIG. 7 on the surface of the light-curing resin, after coating the surface of the micro-lens array template with a mold release agent; exposing the photo-curable resin, and removing the micro-lens array template after the photo-curable resin is cured, and then developing to form a blue pixels 22c with a surface having a micro-lens array structure; and

Step 203, forming a protection layer 4 on the quantum dot light conversion layer 2.

Some embodiments of the present application provide a quantum dot color filter, referring to FIG. 3 and FIG. 5A, and the quantum dot color filter provided in this embodiment includes a transparent base panel 1 formed of glass material, a layer 3 able to transmit blue light and to reflect red light and green light, a quantum dot light conversion layer 2, a micro-lens array 5 formed of polyurethane, and a protection layer 4 formed of glass material, and they are arranged sequentially from bottom to top. The quantum dot light conversion layer 2 includes a plurality of pixels 22 and a black matrix 21 formed of metal of chromium for separating the pixels 22. The pixels 22 includes red pixels 22a, green pixels 22b and blue pixels 22c, wherein the blue pixels 22c may be transparent.

Where the micro-lens array 5 has a convex micro-lens array structure, and the surface of the micro-lens in the micro-lens array structure is a spherical surface. The diameter of the circumference at the bottom of the spherical surface is 2 μm, the height of the spherical surface is 1 μm, and the two adjacent spheres are tangential.

The thickness of the pixels 22 in the quantum dot color filter is 50 μm.

In some embodiments, the photo-curable resin used to form the pixels of the quantum dot color filter is consisted of: matrix resin: methyl methacrylate: photo initiator: benzophenone.

The quantum dot color filter is prepared by the following method:

Step 301: forming a layer 3 able to transmit blue light and to reflect red light and green light on the transparent base panel 1, and forming a black matrix 21 on the layer 3 able to transmit blue light and to reflect red light and green light, by photoengraving and etching processes;

Step 302, filling photo-curable resin mixed with red quantum dot material into the gap of the black matrix 21, to form red pixels 22a after exposing and developing;

filling photo-curable resin mixed with green quantum dot material into the gap of the black matrix 21, to form a green pixels 22b after exposing and developing;

filling photo-curable resin that has not been mixed with quantum dot material into the gap of the black matrix 21, to form a blue pixels 22c after exposing and developing; and

Step 303, heating a polyurethane film having a thickness of 0.5 μm, after placing the polyurethane film on the surface of the micro-lens array template prepared according to the method in the embodiment shown in FIG. 7, to obtain a micro-lens array 5 having the structure of a convex micro-lens array, as shown in FIG. 5A;

Step 304, bonding the micro-lens array 5 obtained in step 303 to the light emitting side of the quantum dot light conversion layer 2, by optical glue; and

Step 305, forming a protection layer 4 on the micro-lens array 5.

Some embodiments of the present application provide a quantum dot color filter, referring to FIG. 3 and FIG. 5B, and the difference between the quantum dot color filter provided in this embodiment and the quantum dot color filter in the embodiment shown in FIG. 3 lies in that the micro-lens array 5 is prepared by the following method:

coating the surface of the micro-lens array template prepared according to the method shown in the embodiment shown in FIG. 7 with mold release agent, filling the micro-lens array template with epoxy resin E-51 and triethylenetetramine curing agent, and heating to curing the epoxy resin to obtain a micro-lens array 5 having a convex micro-lens array structure as shown in FIG. 5B after being demolded.

In some embodiments of the present application, the quantum dot color filter provided in the previous embodiment and the existing quantum dot color filter shown in FIG. 1 are mounted on the liquid crystal panel as shown in FIG. 8A or FIG. 8B respectively, to detect the brightness within the range of the angle-of-view of the liquid crystal panel.

Where, the thickness of the pixels in the existing quantum dot color filter is also 50 μm.

The detection result shows that the angle-of-view of the liquid crystal panel using the existing quantum dot color filter is 153° and the brightness of the center of the angle-of-view is 450 nits, however, the angle-of-view of the liquid crystal panel using the quantum dot color filter according to the embodiments of the present application is 100°, and the brightness of the center of the angle-of-view is 690 nits, with the brightness of the center of the angle-of-view increased by 53%.

In the present application, not greater than refers to greater than or equal to, and not less than refers to equal to or less than.

Overall, by utilizing the features of the light convergence function provided by micro-lens array according to the embodiments of the present application and designing the surface of the light emitting side of the pixels as a micro-lens array structure or arranging a micro-lens array having a micro-lens array structure on the light emitting side of the pixels, the light emitted by the pixels points 22 in the quantum dot color filter is converged into the range of the angle-of-view of the liquid crystal display device, thereby increasing the brightness in the range of the angle-of-view, improving the display effect of the liquid crystal display device, and promoting the development of the high color gamut liquid crystal display device, when the thickness of the quantum dot light conversion layer is relatively thin.

The above description is merely for facilitating those skilled in the art to understand the technical solutions of the present application, and is not intended to limit the present application. Any amendments, equivalent substitutions and improvements made within the spirit and principle of the present application should be included in the protection scope of the present application.

What is claimed is:

1. A quantum dot color filter, comprising: a quantum dot light conversion layer; a base panel arranged on a light incident side of the quantum dot conversion layer; and a protection layer arranged on a light emitting side of the quantum dot conversion layer, wherein a micro-lens array is arranged between the quantum dot conversion layer and the protection layer, and the micro-lens array is configured to converge light emitted from the quantum dot conversion layer.

2. The quantum dot color filter according to claim 1, wherein the micro-lens array is arranged on a surface of the light emitting side of the quantum dot light conversion layer.

3. The quantum dot color filter according to claim 2, wherein the quantum dot light conversion layer comprises a plurality of pixels and a black matrix for separating the pixels, a thickness of the black matrix in a direction from the base panel toward the protection layer is greater than a thickness of the pixels in a direction from the base panel toward the protection layer, and the micro-lens array is arranged on a surface of a light emitting side of the pixels, respectively.

4. The quantum dot color filter according to claim 3, wherein material of the pixels is the same as that of the micro-lens array arranged on the pixels.

5. The quantum dot color filter according to claim 3, wherein a sum of thicknesses of the pixels and the micro-lens array in the direction from the base panel toward the protection layer is not greater than the thickness of the black matrix in a direction from the base panel toward the protection layer.

6. The quantum dot color filter according to claim 3, wherein a side of the black matrix facing the protection layer is in contact with the protection layer.

7. The quantum dot color filter according to claim 2, wherein the quantum dot light conversion layer comprises a plurality of pixels and a black matrix for separating the pixels, a thickness of the black matrix in a direction from the base panel toward the protection layer is equal to a thickness of the pixels in the direction from the base panel toward the protection layer, and the micro-lens array is arranged on a side of both the pixels and the black matrix facing the protection layer, or the micro-lens array is arranged on a side of the plurality of pixels facing the protection layer, respectively.

8. The quantum dot color filter according to claim 6, wherein the micro-lens array and the quantum dot conversion layer are arranged in parallel.

9. The quantum dot color filter according to claim 6, wherein material of the micro-lens array is different from that of the pixels.

10. The quantum dot color filter according to claim 6, wherein the base panel, the quantum dot light conversion layer, the micro-lens array, and the protection layer are laminated, and adjacent layers thereof are in contact with each other.

11. A quantum dot color filter according to claim 2, wherein the quantum dot light conversion layer comprises a plurality of pixels and a black matrix for separating the pixel, a thickness of the black matrix in a direction from the base panel toward the protection layer is smaller than a thickness of the pixels in a direction from the base panel toward the protection layer, and the micro-lens array is arranged on a surface of a light emitting side of the pixels, respectively.

12. The quantum dot color filter according to claim 11, wherein a material of the pixels is the same as that of the micro-lens array arranged on the pixels.

13. The quantum dot color filter according to claim 11, wherein a side of the micro-lens array facing the protection layer is in contact with the protection layer.

14. The quantum dot color filter according to claim 2, wherein the micro-lens array comprises at least one of the following: a cylindrical surface micro-lens array, a spherical micro-lens array, and a prism array.

15. The quantum dot color filter according to claim 14, wherein when the micro-lens array is the spherical micro-lens array, a convex curved surface of a lens in the micro-lens array is a spherical surface, and a diameter of circumference at a bottom end of the convex curved surface is 1-3 μm, and a ratio of a height of the convex curved surface to the diameter is (0.25-0.5):1.

16. A liquid crystal panel comprising the quantum dot color filter according to claim 1.

17. The liquid crystal panel according to claim 16, wherein the micro-lens array is arranged on a surface of the light emitting side of the quantum dot light conversion layer.

18. The liquid crystal panel according to claim 17, wherein the quantum dot light conversion layer comprises a plurality of pixels and a black matrix for separating the pixels, a thickness of the black matrix in a direction from the base panel toward the protection layer is greater than a thickness of the pixels in a direction from the base panel toward the protection layer, and the micro-lens array is arranged on a surface of a light emitting side of the pixels, respectively.

19. The liquid crystal panel according to claim 17, wherein the quantum dot light conversion layer comprises a plurality of pixels and a black matrix for separating the pixels, a thickness of the black matrix in a direction from the base panel toward the protection layer is equal to a thickness of the pixels in a direction from the base panel toward the protection layer, and the micro-lens array is arranged on a side of both the pixels and the black matrix facing the protection layer, or the micro-lens array is arranged on a side of the plurality of pixels facing the protection layer, respectively.

20. A liquid crystal display device comprising at least one set of backlight module, and further comprising the liquid crystal panel according to claim 17.
